(19) United States
(12) Patent Application Publication
(10) Pub. No.: US 2025/0210260 A1
(43) Pub. Date: Jun. 26, 2025

(54) MULTILAYER ELECTRONIC COMPONENT

(71) Applicant: SAMSUNG ELECTRO-MECHANICS CO., LTD., Suwon-si (KR)

(72) Inventors: Kyung Ho LEE, Suwon-si (KR); Jea Yeol CHOI, Suwon-si (KR); Young Ghyu AHN, Suwon-si (KR); Joon Yeob CHO, Suwon-si (KR)

(73) Assignee: SAMSUNG ELECTRO-MECHANICS CO., LTD., Suwon-si (KR)

(21) Appl. No.: 18/965,310

(22) Filed: Dec. 2, 2024

(30) Foreign Application Priority Data
Dec. 22, 2023 (KR) 10-2023-0189538

(51) Int. Cl. H01G 4/012; H01G 4/30

(52) U.S. Cl. CPC H01G 4/012; H01G 4/30

(57) ABSTRACT

A multilayer electronic component includes a body including a dielectric layer and first and second internal electrodes alternately disposed in a first direction with the dielectric layer interposed therebetween, the first and second internal electrodes spaced apart from fifth and sixth surfaces, first and second external electrodes respectively connected to the first and second internal electrodes, a first through-electrode passing through a space in which the second internal electrode and the fifth surface are spaced apart from each other, the first through-electrode disposed between one ends of two adjacent first internal electrodes in the third direction to connect them, and a second through-electrode passing through a space in which the first internal electrode and the sixth surface are spaced apart from each other, the second through-electrode disposed between one ends of two adjacent second internal electrodes in the third direction to connect them.

### CROSS-REFERENCE TO RELATED APPLICATION(S)

This application claims benefit of priority to Korean Patent Application No. 10-2023-0189538 filed on Dec. 22, 2023 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser mounted on the printed circuit boards of various types of electronic products such as imaging devices, including a liquid crystal display (LCD) and a plasma display panel (PDP), computers, smartphones, and mobile phones, and serves to charge or discharge electricity therein or therefrom. Such a multilayer ceramic capacitor may be used as a component of various electronic devices due to having a small size, ensuring high capacitance and being easily mounted.

In general, a process of manufacturing a multilayer ceramic capacitor may include an operation of laminating and compressing a ceramic green sheet on which an internal electrode pattern is printed. In this case, a step may occur between a region of the ceramic green sheet on which the internal electrode pattern is printed and a region of the ceramic green sheet on which the internal electrode pattern is not printed, and an end of the internal electrode pattern may be bent due to the step portion during a compression process.

When the end of the internal electrode pattern is bent, an electric field may be concentrated in a bent portion, and thus high-voltage shock (HVS) may occur in the multilayer ceramic capacitor or insulation resistance (IR) of the multilayer ceramic capacitor may be degraded.

To resolve such an issue, Patent Document 1 introduced a process of forming a side margin portion by cutting a mother laminate to expose an internal electrode pattern on both side surfaces of a ceramic laminate and then coating a ceramic paste on both side surfaces of the ceramic laminate to cover an exposed portion of the internal electrode pattern.

However, when the side margin portion is formed according to the process disclosed in Patent Document 1, a gap between the body and the side margin portion may occur, resulting in a reduction in moisture resistance of a multilayer ceramic capacitor.

### PRIOR ART DOCUMENT

### Patent Document

(Patent Document 1) JP Patent Application Publication No. 2011-023707

### SUMMARY

An aspect of the present disclosure provides a multilayer electronic component having excellent reliability.

However, the aspects of the present disclosure are not limited to those set forth herein, and will be more easily understood in the course of describing specific example embodiments of the present disclosure.

According to an aspect of the present disclosure, there is provided a multilayer electronic component including a body including first and second surfaces opposing each other in a first direction, third and fourth surfaces opposing each other in a second direction and connected to the first and second surfaces, and fifth and sixth surfaces opposing each other in a third direction and connected to the first to fourth surfaces, the body including a dielectric layer, first and second internal electrodes alternately disposed in the first direction with the dielectric layer interposed therebetween, the first and second internal electrodes spaced apart from the fifth and sixth surfaces, a first through-electrode passing through a space in which the second internal electrode and the fifth surface are spaced apart from each other, and disposed between first ends of two adjacent first internal electrodes in the third direction to connect the first ends of the two adjacent first internal electrodes to each other, and a second through-electrode passing through a space in which the first internal electrode and the sixth surface are spaced apart from each other, and disposed between second ends of two adjacent second internal electrodes in the third direction to connect the second ends of the two adjacent second internal electrodes to each other, and first and second external electrodes disposed on the body, and respectively connected to the first and second internal electrodes.

According to example embodiments of the present disclosure, a multilayer electronic component may have excellent reliability.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a multilayer electronic component according to an example embodiment of the present disclosure;

FIG. 2 is a schematic cross-sectional view taken along line I-I′ in FIG. 1;

FIG. 3 is a schematic cross-sectional view taken along line II-II′ in FIG. 1;

FIG. 4 is a schematic enlarged view of region “K1” in FIG. 3;

FIG. 5 is a schematic cross-sectional view taken along line III-III′ in FIG. 2;

FIG. 6 is a schematic cross-sectional view taken along line IV-IV′ in FIG. 2;

FIG. 7 is a diagram illustrating an overlap of FIG. 5 and FIG. 6;

FIG. 8 is a modification of the embodiment illustrated in FIG. 7;

FIGS. 9 and 10 are schematic diagrams illustrating a process of manufacturing a multilayer electronic component according to an example embodiment of the present disclosure;

FIG. 11 is a schematic perspective view of a multilayer electronic component according to another example embodiment of the present disclosure;

FIG. 12 is a schematic cross-sectional view taken along line V-V′ in FIG. 11;

FIG. 13 is a plan view of a first internal electrode and a second through-electrode of a multilayer electronic component illustrated in FIG. 11;

FIG. 14 is a plan view of a second internal electrode and a first through-electrode of a multilayer electronic component illustrated in FIG. 11;

FIG. 15 is a diagram illustrating an overlap of FIG. 13 and FIG. 14;

FIG. 16 is a schematic perspective view of a multilayer electronic component according to another example embodiment of the present disclosure; and

FIG. 17 is a schematic cross-sectional view taken along line VI-VI′ in FIG. 16.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

In order to clearly illustrate the present disclosure, portions not related to the description are omitted, and sizes and thicknesses are magnified in order to clearly represent layers and regions, and similar portions having the same functions within the same scope are denoted by similar reference numerals throughout the specification. Throughout the specification, when an element is referred to as “comprising” or “including,” it means that it may include other elements as well, rather than excluding other elements, unless specifically stated otherwise.

In the drawings, a first direction may be defined as a thickness (T) direction, a second direction may be defined as a length (L) direction, and a third direction may be defined as a width (W) direction.

### Multilayer Electronic Component

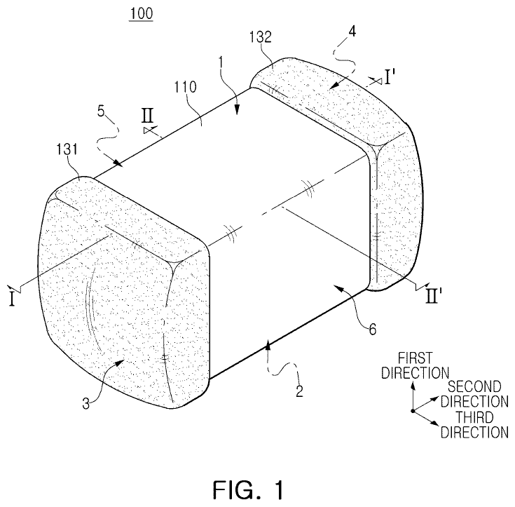

FIG. 1 is a schematic perspective view of a multilayer electronic component according to an example embodiment of the present disclosure.

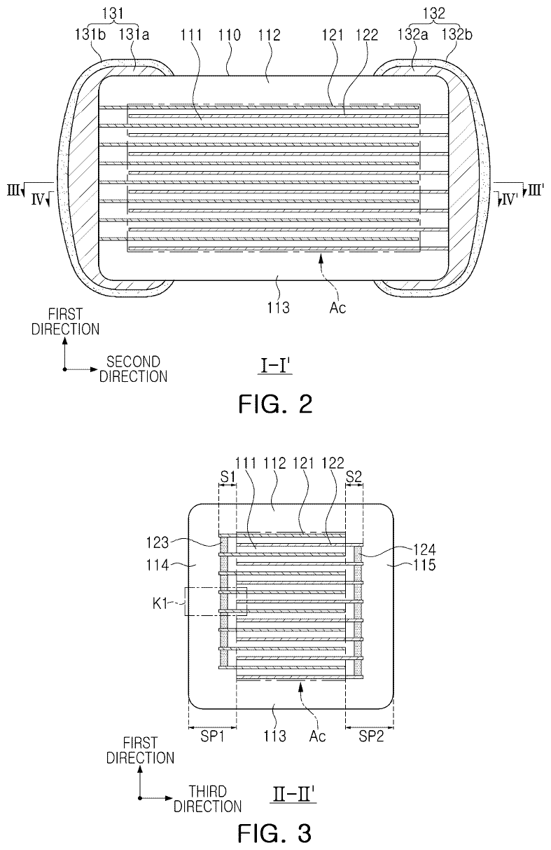

FIG. 2 is a schematic cross-sectional view taken along line I-I′ in FIG. 1.

FIG. 3 is a schematic cross-sectional view taken along line II-II′ in FIG. 1.

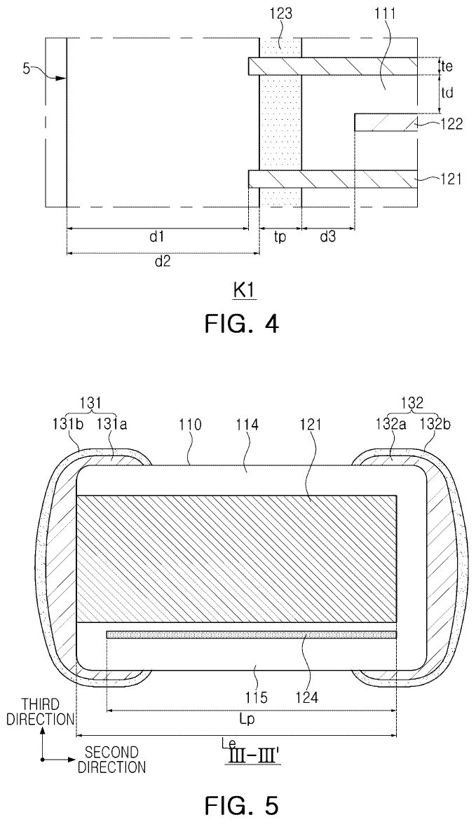

FIG. 4 is a schematic enlarged view of region “K1” in FIG. 3.

FIG. 5 is a schematic cross-sectional view taken along line III-III′ in FIG. 2.

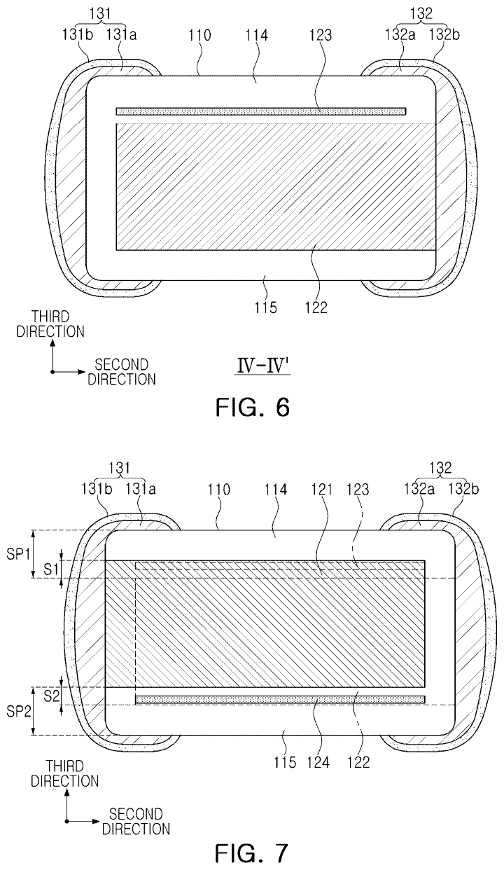

FIG. 6 is a schematic cross-sectional view taken along line IV-IV′ in FIG. 2.

FIG. 7 is a diagram illustrating an overlap of FIG. 5 and FIG. 6.

Hereinafter, a multilayer electronic component 100 according to an example embodiment of the present disclosure will be described in detail with reference to FIGS. 1 to 7. In addition, a multilayer ceramic capacitor (hereinafter referred to as “MLCC”) is described as an example of the multilayer electronic component, but the present disclosure is not limited thereto, and may be applied to various electronic products, such as inductors, piezoelectric elements, varistors, thermistors, or the like.

A size of the multilayer electronic component 100 is not particularly limited. A length (L size) of the multilayer electronic component 100 in the second direction may be, for example, 0.2 mm to 3.2 mm, a width (W size) of the multilayer electronic component 100 in the third direction may be, for example, 0.1 mm to 1.6 mm, and a thickness (T size) of the multilayer electronic component 100 in the first direction may be, for example, 0.05 mm to 2.0 mm.

The multilayer electronic component 100 may include a body 110, external electrodes 131 and 132, and through-electrodes 123 and 124.

A specific shape of the body 110 is not particularly limited. However, as illustrated, the body 110 may have a hexahedral shape or a shape similar thereto. During a sintering process, ceramic powder particles, included in the body 110, may shrink or an edge portion of the body 110 may be polished, such that the body 110 may not have a hexahedral shape having perfectly straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

The body 110 may include a dielectric layer 111 and internal electrodes 121 and 122 disposed alternately with the dielectric layer 111. A plurality of dielectric layers 111, included in the body 110, may be in a sintered state, and adjacent dielectric layers 111 may be integrated with each other such that boundaries therebetween are not readily apparent without using a scanning electron microscope (SEM).

The dielectric layer 111 may include, for example, a perovskite-type compound, represented by ABO₃, as a main component. The perovskite-type compound, represented by ABO₃, may be, for example, CaZrO₃, (Ca₁₋ₓSrₓ)(Zr_{1-y}Ti_{y})O₃ (0<x≤0.5, 0<y≤0.5), BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1,0<y<1), or Ba(Ti_{1-y}Zr_{y})O₃ (0<y<1).

An average thickness of the dielectric layer 111 is not particularly limited. The average thickness of the dielectric layer 111 may be, for example, 0.1 to 20 μm, 0.1 to 10 μm, 0.1 to 5 μm, 0.1 to 2 μm, or 0.1 to 0.4 μm.

The internal electrodes 121 and 122 may include, for example, a first internal electrode 121 and a second internal electrode 122 alternately disposed in a first direction with the dielectric layer 111 interposed therebetween. That is, the first internal electrode 121 and the second internal electrode 122, a pair of electrodes having different polarities, may be disposed to oppose each other with the dielectric layer 111 interposed therebetween. The first internal electrode 121 and the second internal electrode 122 may be electrically isolated from each other by the dielectric layer 111 interposed therebetween.

The first internal electrode 121 may be spaced apart from the fourth surface 4, and may be exposed to the third surface 3. The second internal electrode 122 may be spaced apart from the third surface 3, and may be exposed to the fourth surface 4. The first and second internal electrodes 121 and 122 may be disposed to be spaced apart from the fifth and sixth surfaces 5 and 6.

The first internal electrode 121 and the second internal electrode 122 may be disposed to be misaligned with each other in the third direction. For example, a distance in the third direction between the first internal electrode 121 and the fifth surface 5 may be shorter than a distance in the third direction between the first internal electrode 121 and the sixth surface 6, and a distance in the third direction between the second internal electrode 122 and the sixth surface 6 may be shorter than a distance in the third direction between the second internal electrode 122 and the fifth surface 5.

A conductive metal, included in the internal electrodes 121 and 122, may be one or more of Ni, Cu, Pd, Ag, Au, Pt, Sn, W, Ti, and alloys thereof, and may preferably include Ni, but the present disclosure is not limited thereto.

An average thickness of each of the internal electrodes 121 and 122 is not particularly limited. The average thickness of each of the internal electrodes 121 and 122 may be, for example, 0.1 μm to 3.0 μm, 0.1 μm to 1.0 μm, or 0.1 μm to 0.4 μm.

The average thickness of the dielectric layer 111 and the average thickness of each of the internal electrodes 121 and 122 may respectively refer to a size of the dielectric layer 111 in the first direction, and a size of each of the internal electrodes 121 and 122 in the first direction. The average thickness of the dielectric layer 111 and the average size of each of the internal electrodes 121 and 122 may be measured, for example, by scanning, with an SEM, a cross-section of the body 110 in the first and second directions at a magnification of 10,000. More specifically, the average thickness of the dielectric layer 111 may be measured by measuring thicknesses of one dielectric layer 111 at multiple points of the dielectric layer 111, for example, thirty points equally spaced apart from each other in the second direction, and calculating an average value of the thicknesses. In addition, the average thickness of each of the internal electrodes 121 and 122 may be measured by measuring thicknesses of each of the internal electrodes 121 and 122 at multiple points of each of the internal electrodes 121 and 122, for example, thirty points equally spaced apart from each other in the second direction, and calculating an average value of the thicknesses. The thirty points, equally spaced apart from each other, may be designated in a capacitance formation portion Ac. When such average value measurement is performed on ten dielectric layers 111 and ten internal electrodes 121 and 122, the average thickness of the dielectric layer 111 and the average thickness of each of the internal electrodes 121 and 122 may be further generalized.

The body 110 may include a capacitance formation portion Ac disposed in the body 110, the capacitance formation portion Ac including a first internal electrode 121 and a second internal electrode 122, with the dielectric layer 111 interposed therebetween, to form capacitance, and a first cover portion 112 and a second cover portion 113, respectively disposed on both surfaces of the capacitance formation portion Ac opposing each other in the first direction. The cover portions 112 and 113 may basically serve to prevent damage to an internal electrode caused by physical or chemical stress. The cover portions 112 and 113 may have a configuration similar to that of the dielectric layer 111, except that an internal electrode is not included.

An average thickness of each of the cover portions 112 and 113 is not particularly limited. The average thickness of each of the cover portions 112 and 113 may be, for example, 150 μm or less, 100 μm or less, 30 μm or less, or 20 μm or less. The average thickness of each of the cover portions 112 and 113 may be, for example, 5 μm or more, 10 μm or more, or 30 μm or more. Here, the average thickness of each of the cover portions 112 and 113 may refer to an average thickness of each of the first cover portion 112 and the second cover portion 113.

The average thickness of each of the cover portions 112 and 113 may refer to an average thickness of each of the cover portions 112 and 113 in the first direction, and may be an average value of thicknesses of each of the cover portions 112 and 113 in the first direction, measured at five equally spaced points in the second direction in the cross-section of the body 110 in the first and second directions.

The body 110 may include a first side portion S1 disposed on one side of the capacitance formation portion Ac in the third direction, the first side portion S1 in which adjacent first internal electrodes 121, among a plurality of first internal electrodes 121, overlap each other in the first direction without the second internal electrode 122 interposed therebetween, and a second side portion S2 disposed on the other side of the capacitance formation portion Ac in the third direction, the second side portion S2 in which adjacent second internal electrodes 122, among a plurality of second internal electrodes 122, overlap each other in the first direction without the first internal electrode 121 interposed therebetween.

The body 110 may include a first margin portion 114 disposed between the first side portion S1 and the fifth surface 5, and a second margin portion 115 disposed between the second side portion S2 and the sixth surface 6. That is, each of the margin portions 114 and 115 may refer to a region between both ends of each of the internal electrodes 121 and 122 and a boundary surface of the body 110 in a cross-section of the body 110 in the first and third directions. The margin portions 114 and 115 may have a configuration similar to that of the dielectric layer 111, except that the internal electrodes 121 and 122 are not included.

The external electrodes 131 and 132 may include first and second external electrodes 131 and 132 disposed on the body 110, the first and second external electrodes 131 and 132 respectively connected to the first and second internal electrodes 121 and 122. The first external electrode 131 may be disposed on the third surface 3, and the second external electrode 132 may be disposed on the fourth surface 4. The first external electrode 131 may be disposed on the third surface 3 to extend onto portions of the first surface, the second surface, the fifth surface and the sixth surfaces 1, 2, 5, and 6, and the second external electrode 132 may be disposed on the fourth surface 4 to extend onto portions of the first surface, the second surface, the fifth surface and the sixth surface 1, 2, 5, and 6.

A type or shape of the external electrode is not particularly limited, and the external electrode may have a multilayer structure. For example, the external electrodes 131 and 132 may include base electrode layers 131a and 132a in contact with the internal electrodes 121 and 122, and plating layers 131b and 132b disposed on the base electrode layers 131a and 132a.

The base electrode layers 131a and 132a may be sintered electrodes including a metal and glass. The metal, included in the base electrode layers 131a and 132a, may include Cu, Ni, Pd, Pt, Au, Ag, Pb, and/or an alloy including the same, but the present disclosure is not limited thereto. The glass, included in the base electrode layers 131a and 132a, may include one or more oxides of Ba, Ca, Zn, Al, B, and Si, but the present disclosure is not limited thereto.

The base electrode layers 131a and 132a may be formed of only a first layer including a metal and glass, but the present disclosure is not limited thereto, and the base electrode layers 131a and 132a may have a multilayer structure. For example, the base electrode layers 131a and 132a may include a first layer including a metal and glass, and a second layer disposed on the first layer, the second layer including a metal and a resin.

The metal, included in the second layer, may include one or more of spherical particles and flake-type particles. Here, the spherical particles may have a shape that is not completely spherical, for example, a shape in which a length ratio (long axis/short axis) between a long axis and a short axis is 1.45 or less. The flake-type particles may refer to particles having a flat and elongated shape, but the present disclosure is not limited thereto. For example, the flake-type particles may have a shape in which a length ratio (long axis/short axis) between a long axis and a short axis may be 1.95 or more. The metal, included in the second layer, may include, for example, Cu, Ni, Pd, Pt, Au, Ag, Pb, Sn and/or an alloy including the same. The resin, included in the second layer, may include, for example, one or more of an epoxy resin, an acrylic resin, and ethyl cellulose.

The plating layers 131b and 132b may improve mounting properties. The plating layers 131b and 132b may include Ni, Sn, Pd, and/or an alloy including the same, and may be formed of a plurality of layers. The plating layers 131b and 132b may be, for example, a Ni plating layer or a Sn plating layer, or may be a Ni plating layer and a Sn plating layer, sequentially formed. In addition, the plating layers 131b and 132b may include a plurality of Ni plating layers and/or a plurality of Sn plating layers.

In the drawings, a structure is illustrated in which the multilayer electronic component 100 has two external electrodes 131 and 132, but the present disclosure is not limited thereto, and the number or shapes of the external electrodes 131 and 132 may be changed depending on shapes of the internal electrodes 121 and 122 or other purposes.

The multilayer electronic component 100 may include, for example, a first through-electrode 123 passing through a space SP1 in which the second internal electrode 122 and the fifth surface 5 are spaced apart from each other, and disposed between one ends of two adjacent first internal electrodes 121 in the third direction to connect the one ends of two adjacent first internal electrodes 121 to each other, and a second through-electrode 124 passing through a space SP2 in which the first internal electrode 121 and the sixth surface 6 are spaced apart from each other, and disposed between one ends of two adjacent second internal electrodes 122 in the third direction to connect the one ends of two adjacent second internal electrodes 122 to each other. The multilayer electronic component 100 may include, for example, a first through-electrode 123 disposed in the first side portion S1 and connecting adjacent first internal electrodes 121, among the plurality of first internal electrodes 121, to each other, and a second through-electrode 124 disposed in the second side portion S2 and connecting adjacent second internal electrodes 122, among the plurality of second internal electrodes 122, to each other.

As described above, in a process of manufacturing a multilayer electronic component according to the related art, a step may occur between a region of a ceramic green sheet on which an internal electrode pattern is printed and a region of the ceramic green sheet on which the internal electrode pattern is not printed, and an end of an internal electrode in the third direction may be bent toward a central portion of a body due to the step after compression and sintering. In this case, an electric field is concentrated on the end of the internal electrode in the third direction, and HVS may occur in the multilayer electronic component or IR of the multilayer ceramic capacitor may be degraded.

Conversely, according to an example embodiment of the present disclosure, the first through-electrode 123 may be disposed between the one ends of the two adjacent first internal electrodes 121 in the third direction, and the second through-electrode 124 may be disposed between the one ends of the two adjacent second internal electrodes 122 in the third direction, thereby suppressing bending of the ends of the internal electrodes 121 and 122 in the third direction toward the central portion of the body 110. As a result, the electric field may be prevented from being concentrated on a bent portion, thereby preventing HVS from occurring and/or IR from degrading.

Referring to FIG. 4, in an example embodiment, when a distance in the third direction between the fifth surface 5 and the first internal electrode 121 is denoted by d1, and a distance in the third direction between the fifth surface 5 and the first through-electrode 123 is denoted by d2, d2>d1 may be satisfied. As will be described below, the first through-electrode 123 may be formed by forming a through-hole in a ceramic green sheet and then filling the through-hole with a conductive paste. In this case, d2−d1 may be a process margin for disposing the first through-electrode 123 between the ends of the two adjacent first internal electrodes 121. That is, a through-hole may be formed in the ceramic green sheet and the through-hole may be filled with a conductive paste, such that the through-electrodes 123 and 124 may be formed integrally with the body 110, and through-electrodes or margin portions may not need to be additionally formed on both side surfaces of the body. As a result, an electric field concentration phenomenon may be prevented without reducing moisture resistance reliability of the multilayer electronic component 100. The distances d1 and d2 may be measured by SEM. Other methods and/or tools appreciated by one of ordinary skill in the art, even if not described in the present disclosure, may also be used.

In an example embodiment, when a thickness of the first internal electrode 121 is denoted by te and a thickness of the first through-electrode 123 is denoted by tp, tp>te may be satisfied. When tp>te is satisfied, a phenomenon in which an end of the first internal electrode 121 is bent may be more effectively prevented. An upper limit of tp is not particularly limited, but tp may be 3×te or less. The thicknesses tp and te may be measured by SEM. Other methods and/or tools appreciated by one of ordinary skill in the art, even if not described in the present disclosure, may also be used.

In an example embodiment, when a thickness of the dielectric layer 111 is denoted by td and a distance in the second direction between the first through-electrode 123 and the second internal electrode 122 is denoted by d3, d3>td may be satisfied. When the first through-electrode 123 and the second internal electrode 122 come into contact with each other, a short circuit may occur, and thus d3 may preferably be greater than td. An upper limit of d3 is not particularly limited. However, in order to prevent capacitance of the multilayer electronic component 100 from being excessively reduced, d3 may be 3×td or less. The thickness td and the distances d3 may be measured by SEM. Other methods and/or tools appreciated by one of ordinary skill in the art, even if not described in the present disclosure, may also be used.

The first through-electrode 123 and the second through-electrode 124 have substantially the same configuration, and thus descriptions of the first through-electrode 123 provided with reference to FIG. 4 may be applied to the second through-electrode 124 without any change.

Referring to FIGS. 5 to 7, the first through-electrode 123 may extend in the second direction, and may be spaced apart from the second external electrode 132, and the second through-electrode 124 may extend in the second direction, and may be spaced apart from the first external electrode 131. As a length of each of the through-electrodes 123 and 124 in the second direction increases, bending of the ends of the internal electrodes may be more effectively prevented. However, as the length of each of the through-electrodes 123 and 124 in the second direction increases, a short circuit may occur due to contact with the external electrodes 132 and 131 having different polarities. In an example embodiment, the first through-electrode 123 may be spaced apart from the first external electrode 131, and the second through-electrode 124 may be spaced apart from the second external electrode 132.

The length of each of the through-electrodes is not particularly limited. However, when a length of the first internal electrode 121 in the second direction is denoted by Le and a length of the second through-electrode 124 in the second direction is denoted by Lp, Le>Lp may be satisfied. A lower limit of Lp is not particularly limited. However, Lp>0.6×Le may be satisfied in order to effectively prevent bending of the ends of the internal electrodes. The lengths Lp and Le may be measured by SEM. Other methods and/or tools appreciated by one of ordinary skill in the art, even if not described in the present disclosure, may also be used.

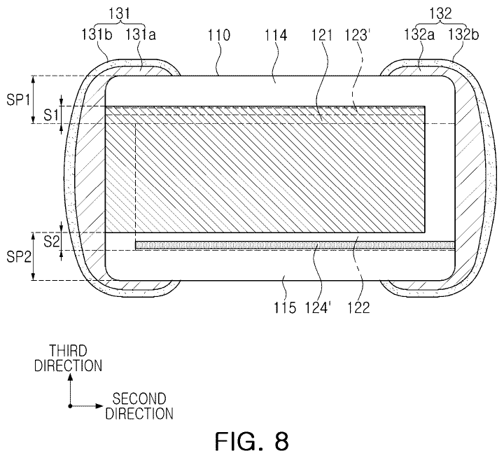

FIG. 8 is a modification of the embodiment illustrated in FIG. 7. For example, referring to FIG. 8, the first through-electrode 123′ may be connected to the first external electrode 131, and the second through-electrode 124′ may be connected to the second external electrode 132. According to the modification illustrated in FIG. 8, a length of the first through-electrode 123′ in the second direction may be substantially the same as a length of the first internal electrode 121 in the second direction, and a length of the second through-electrode 124′ in the second direction may be substantially the same as a length of the second internal electrode 122 in the second direction.

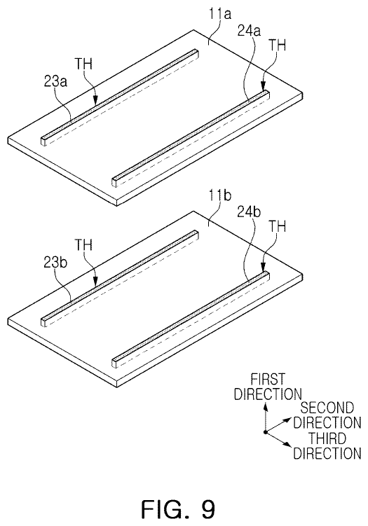

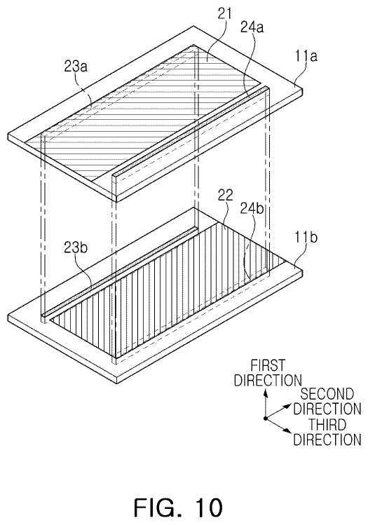

FIGS. 9 and 10 are schematic diagrams illustrating a process of manufacturing a multilayer electronic component according to an example embodiment of the present disclosure. Hereinafter, an example of a method of manufacturing the multilayer electronic component 100 according to an example embodiment of the present disclosure will be described with reference to FIGS. 9 and 10.

First, ceramic powder particles for forming ceramic green sheets 11a and 11b may be prepared. The ceramic powder particles may be CaZrO₃, (Ca₁₋ₓSrₓ)(Zr_{1-y}Ti_{y})O₃ (0<x≤0.5, 0<y≤0.5), BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1). BaTiO₃ powder particles may be synthesized, for example, by reacting a titanium raw material such as titanium dioxide with a barium raw material such as barium carbonate. A method of synthesizing the ceramic powder particles may include, for example, a solid-phase method, a sol-gel method, and a hydrothermal synthesis method, but the present disclosure is not limited thereto. Subsequently, the prepared ceramic powder particles may be dried and ground, an organic solvent such as ethanol and a binder such as polyvinyl butyral may be mixed to prepare a ceramic slurry, and then the ceramic slurry may be coated and dried on a carrier film to prepare the ceramic green sheets 11a and 11b.

Subsequently, two through-holes TH, spaced apart from each other, may be formed in a first ceramic green sheet 11a. A first through-electrode pattern 23a and a second through-electrode pattern 24a may be formed by respectively filling the two through-holes TH with a conductive paste. Afterwards, as illustrated in FIG. 10, a first internal electrode pattern 21 may be formed on the first ceramic green sheet 11a. In this case, the first internal electrode pattern 21 may be connected to the first through-electrode pattern 23a, and may be spaced apart from the second through-electrode pattern 24a.

Similarly, two through-holes TH, spaced apart from each other, may be formed in a second ceramic green sheet 11b. A third through-electrode pattern 23b and a fourth through-electrode pattern 24b may be formed by respectively filling the two through-holes TH with a conductive paste. Thereafter, as illustrated in FIG. 10, a second internal electrode pattern 22 may be formed on the second ceramic green sheet 11b. In this case, the second internal electrode pattern 22 may be connected to the fourth through-electrode pattern 24b, and may be spaced apart from the third through-electrode pattern 23b.

The internal electrode patterns 21 and 22 may be formed by printing a conductive paste for an internal electrode, including metal powder particles, a binder, an organic solvent or the like using a screen-printing method, a gravure-printing method, or the like.

Thereafter, the first and second ceramic green sheets 11a and 11b, peeled off from the carrier film, may be alternately laminated to correspond to a predetermined number of layers and then compressed to form a body on which sintering has not been performed. In this case, the first through-electrode pattern 23a of the first ceramic green sheet 11a and the third through-electrode pattern 23b of the second ceramic green sheet 11b may form the first through-electrode 123 on which sintering has been performed. In addition, the second through-electrode pattern 24a of the first ceramic green sheet 11a and the fourth through-electrode pattern 24b of the second ceramic green sheet 11b may form the second through-electrode 124 on which sintering has been performed. In order to form the cover portions 112 and 113 on which sintering has been performed, a ceramic green sheet on which a through-hole and an internal electrode pattern are not formed may be laminated on upper and lower portions of the body on which sintering has not been performed to correspond to a predetermined number of layers. Thereafter, the body 110 may be formed by sintering the body on which sintering has not been performed at a temperature of 1000°° C. to 1400°° C. FIGS. 9 and 10 illustrate that one internal electrode pattern 21 or one internal electrode pattern 22 are formed on the ceramic green sheet 11a or the ceramic green sheet 11b. However, a ceramic laminate may be formed by laminating and compressing a plurality of through-holes TH and a plurality of ceramic green sheets 11a and 11b having a plurality of internal electrode patterns 21 and 22, and then the ceramic laminate may be cut into chip units and sintered to form the body 110.

Thereafter, the body 110 may be dipped in a conductive paste including metal powder particles, a glass frit, a binder, and an organic solvent, and then the conductive paste may be sintered to form base electrode layers 131a and 132a. When the base electrode layers 131a and 132a include a first layer including a metal and glass, and a second layer including a metal and a resin, the second layer may be formed on the first layer by dipping in a conductive resin composition including metal powder particles, a resin, a binder, and an organic solvent, and then performing curing heat treatment at a temperature of 250° C. to 550° C.

Subsequently, the multilayer electronic component 100 may be manufactured by forming the plating layers 131b and 132b using an electroplating method and/or an electroless plating method. However, the above-described manufacturing method may be an example, and the method of manufacturing the multilayer electronic component 100 is not limited to the above-described manufacturing method.

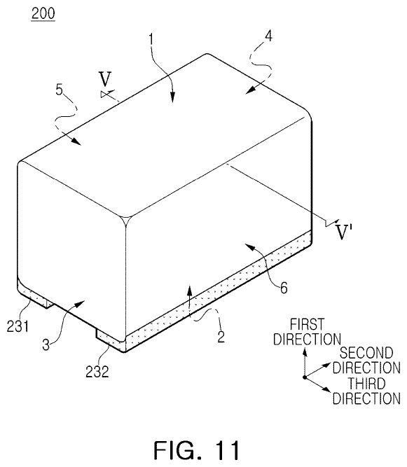

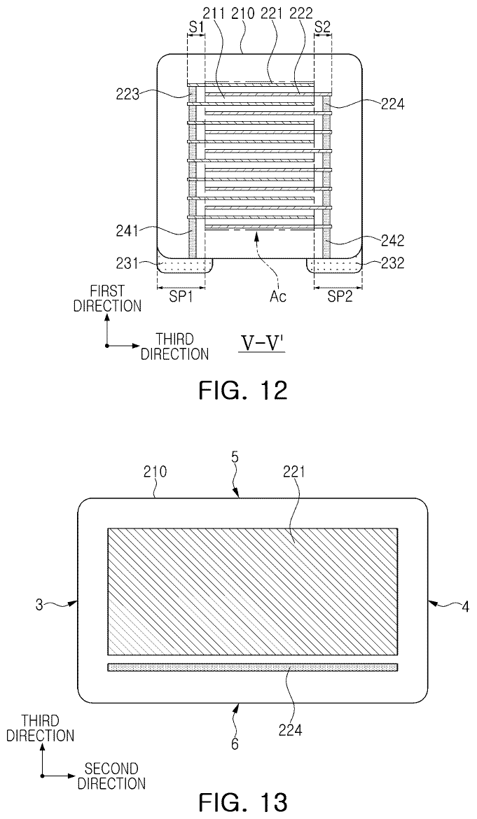

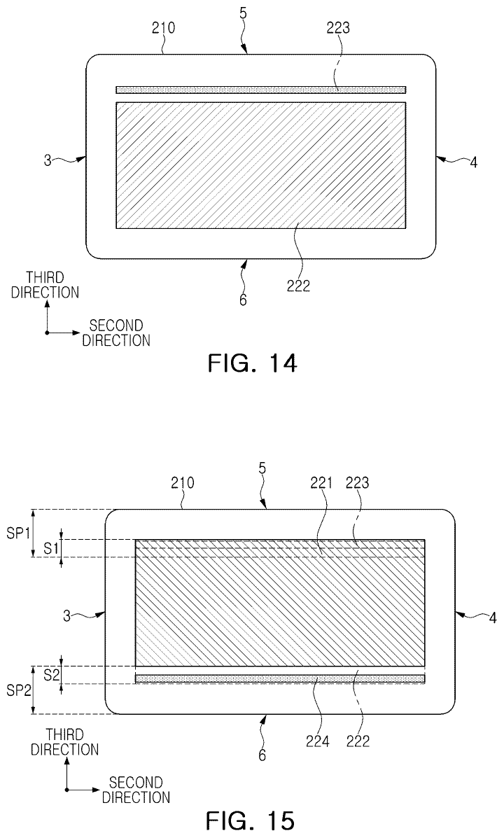

FIG. 11 is a schematic perspective view of a multilayer electronic component according to another example embodiment of the present disclosure. FIG. 12 is a schematic cross-sectional view taken along line V-V′ in FIG. 11. FIG. 13 is a plan view of a first internal electrode and a second through-electrode of a multilayer electronic component illustrated in FIG. 11. FIG. 14 is a plan view of a second internal electrode and a first through-electrode of a multilayer electronic component illustrated in FIG. 11. FIG. 15 is a diagram illustrating an overlap of FIG. 13 and FIG. 14.

Hereinafter, a multilayer electronic component 200 according to another example embodiment of the present disclosure will be described with reference to FIGS.

11 to 15. The same/similar reference numerals are used for components the same as/similar to those of the multilayer electronic component 100 illustrated in FIGS. 1 to 7, and thus repeated descriptions will be omitted.

The multilayer electronic component 200 according to an example embodiment of the present disclosure may include a body 210 including a dielectric layer 211 and a first internal electrode 221 and a second internal electrode 222 alternately disposed in the first direction with the dielectric layer 211 interposed therebetween, and first and second external electrodes 231 and 232 disposed on the body 210, the first and second external electrodes 231 and 232 respectively connected to the first and second internal electrodes 221 and 222. The first internal electrode 221 may be disposed to be spaced apart from third to sixth surfaces 3, 4, 5, and 6, and the second internal electrode 222 may be disposed to be spaced apart from the third to sixth surfaces 3, 4, 5, and 6.

The multilayer electronic component 200 may include, for example, a first through-electrode 223 passing through a space SP1 in which the second internal electrode 222 and the fifth surface 5 are spaced apart from each other, and disposed between one ends of two adjacent first internal electrodes 221 in the third direction to connect the one ends of two adjacent first internal electrodes 221 to each other, and a second through-electrode 224 passing through a space SP2 in which the first internal electrode 221 and the sixth surface 6 are spaced apart from each other, and disposed between one ends of two adjacent second internal electrodes 222 in the third direction to connect the one ends of two adjacent second internal electrodes 222 to each other. The multilayer electronic component 200 may include, for example, a first through-electrode 223 disposed in the first side portion S1 and connecting adjacent first internal electrodes 221, among a plurality of first internal electrodes 221, to each other, and a second through-electrode 224 disposed in a second side portion S2 and connecting adjacent second internal electrodes 222, among a plurality of second internal electrodes 222, to each other. The first through-electrode 223 may be disposed to be spaced apart from the third to sixth surfaces 3, 4, 5, and 6, and the second through-electrode 224 may be disposed to be spaced apart from the third to sixth surfaces 3, 4, 5, and 6.

According to an example embodiment of the present disclosure, each of the first and second external electrodes 231 and 232 may be disposed on a second surface 2. That is, the first and second external electrodes 231 and 232 may have a lower electrode structure in which the external electrodes 231 and 232 are disposed only on the second surface 2, a surface on which the multilayer electronic component 200 is mounted. The first and second external electrodes 231 and 232 may be disposed on the second surface 2 to be spaced apart from each other in the third direction. The first and second external electrodes 231 and 232 may extend in the second direction. A length of the first external electrode 231 in the second direction may be greater than a width of the first external electrode 231 in the third direction, and a length of the second external electrode 232 in the second direction may be greater than a width of the second external electrode 232 in the third direction.

The multilayer electronic component 200 may include a first connection electrode 241 passing through a portion of the body 210 to connect a first internal electrode 221, most adjacent (closest) to the second surface 2, and the first external electrode 231, and a second connection electrode 242 passing through a portion of the body 210 to connect a second internal electrode 222, most adjacent (closest) to the second surface 2, and the second external electrode 232. The first and second connection electrodes 241 and 242 may have configurations similar to those of the through-electrodes 223 and 224, except that the first and second connection electrodes 241 and 242 are in contact with the first and second external electrodes 231 and 232, respectively.

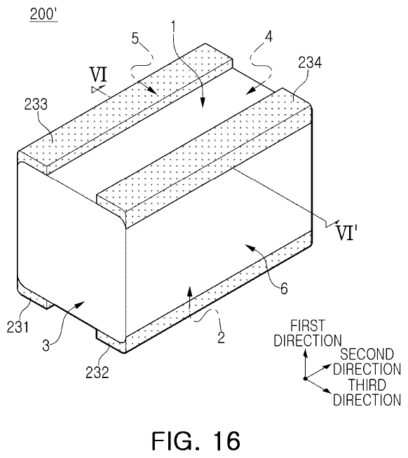

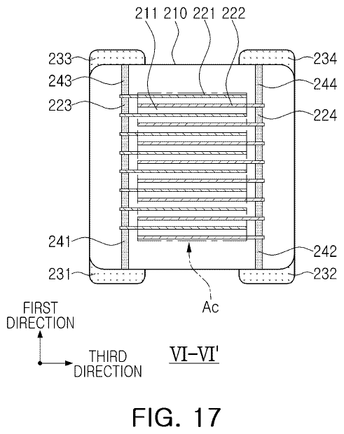

FIG. 16 is a schematic perspective view of a multilayer electronic component according to another example embodiment of the present disclosure. FIG. 17 is a schematic cross-sectional view taken along line VI-VI′ in FIG. 16.

Hereinafter, a multilayer electronic component 200′ according to another example embodiment of the present disclosure will be described with reference to FIGS. 16 and 17. The same/similar reference numerals are used for components the same as/similar to those of the multilayer electronic component 200 illustrated in FIGS. 11 to 15, and thus repeated descriptions will be omitted.

The multilayer electronic component 200′ according to an example embodiment of the present disclosure may include first and second external electrodes 231 and 232 disposed on a second surface 2 to be spaced apart from each other, and third and fourth external electrodes 233 and 234 disposed on a first surface 1 to be spaced apart from each other. The third and fourth external electrodes 233 and 234 may be disposed on the first surface 1 to be spaced apart from each other in the third direction. The first to fourth external electrodes 231, 232, 233, and 234 extend in the second direction, and a length of each of the first to fourth external electrodes 231, 232, 233, and 234 in the second direction may be greater than a width of each of the first to fourth external electrodes 231, 232, 233, and 234 in the third direction.

The multilayer electronic component 200′ may include a third connection electrode 243 passing through a portion of a body 210 to connect a first internal electrode 221, most adjacent (closest) to the first surface 1, and the third external electrode 233, and a fourth connection electrode 244 passing through a portion of the body 210 to connect a second internal electrode 222, most adjacent (closest) to the first surface 1, and a fourth external electrode 234. The third and fourth connection electrodes 243 and 244 may have similar configurations to those of the through-electrodes 223 and 224, except that the third and fourth connection electrodes 243 and 244 are in contact with the third and fourth external electrodes 233 and 234, respectively.

While example embodiments have been illustrated and described above, it will be apparent to those skilled in the art that modifications and variations could be made without departing from the scope of the present disclosure as defined by the appended claims.

In addition, the term “an example embodiment” used herein does not refer to the same example embodiment, and is provided to emphasize a particular feature or characteristic different from that of another example embodiment. However, example embodiments provided herein are considered to be able to be implemented by being combined in whole or in part one with one another. For example, one element described in a particular example embodiment, even if it is not described in another example embodiment, may be understood as a description related to another example embodiment, unless an opposite or contradictory description is provided therein.

As used herein, the terms “first,” “second,” and the like may be used to distinguish a component from another component, and may not limit a sequence and/or an importance, or others, in relation to the components. In some cases, a first component may be referred to as a second component, and similarly, a second component may be referred to as a first component without departing from the scope of the example embodiments.

What is claimed is:

1. A multilayer electronic component comprising:
a body comprising first and second surfaces opposing each other in a first direction, third and fourth surfaces opposing each other in a second direction and connected to the first and second surfaces, and fifth and sixth surfaces opposing each other in a third direction and connected to the first to fourth surfaces, the body including:
a dielectric layer;
first and second internal electrodes alternately disposed in the first direction with the dielectric layer interposed therebetween, the first and second internal electrodes spaced apart from the fifth and sixth surfaces;
a first through-electrode passing through a space in which the second internal electrodes and the fifth surface are spaced apart from each other, and disposed between first ends of two adjacent first internal electrodes in the third direction to connect the first ends of the two adjacent first internal electrodes to each other; and
a second through-electrode passing through a space in which the first internal electrodes and the sixth surface are spaced apart from each other, and disposed between second ends of two adjacent second internal electrodes in the third direction to connect the second ends of the two adjacent second internal electrodes to each other; and
first and second external electrodes disposed on the body and respectively connected to the first and second internal electrodes.

2. The multilayer electronic component of claim 1, wherein, when a distance in the third direction between the fifth surface and at least one of the first internal electrodes is denoted by dl and a distance in the third direction between the fifth surface and the first through-electrode is denoted by d2, d2>d1 is satisfied.

3. The multilayer electronic component of claim 1, wherein the first internal electrodes are disposed to be misaligned with the second internal electrodes in the third direction.

4. The multilayer electronic component of claim 1, wherein
the first through-electrode extends in the second direction, and is spaced apart from the second external electrode, and
the second through-electrode extends in the second direction, and is spaced apart from the first external electrode.

5. The multilayer electronic component of claim 1, wherein
the first through-electrode is spaced apart from the first external electrode, and
the second through-electrode is spaced apart from the second external electrode.

6. The multilayer electronic component of claim 1, wherein
the first through-electrode is connected to the first external electrode, and
the second through-electrode is connected to the second external electrode.

7. The multilayer electronic component of claim 1, wherein, when a thickness of at least one of the first internal electrodes is denoted by te and a thickness of the first through-electrode is denoted by tp, tp>te is satisfied.

8. The multilayer electronic component of claim 1, wherein, when a thickness of the dielectric layer is denoted by td and a distance in the second direction between the first through-electrode and at least one of the second internal electrodes is denoted by d3, d3>td is satisfied.

9. The multilayer electronic component of claim 1, wherein, when a length of at least one of the first internal electrodes in the second direction is denoted by Le and a length of the second through-electrode in the second direction is denoted by Lp, Le>Lp is satisfied.

10. The multilayer electronic component of claim 1, wherein
the first and second internal electrodes respectively extend from the third and fourth surfaces, and
the first and second external electrodes are respectively disposed on the third and fourth surfaces.

11. The multilayer electronic component of claim 1, wherein
each of the first and second external electrodes is disposed on the second surface, and
the multilayer electronic component further includes a first connection electrode passing through a portion of the body to connect a first internal electrode, among the first internal electrodes, that is closest to the second surface, and the first external electrode, and a second connection electrode passing through a portion of the body to connect a second internal electrode, among the second internal electrodes, that is closest to the second surface, and the second external electrode.

12. The multilayer electronic component of claim 11, wherein the first internal electrodes are spaced apart from the third and fourth surfaces, and the second internal electrodes are spaced apart from the third and fourth surfaces.

13. The multilayer electronic component of claim 11, further comprising:
third and fourth external electrodes disposed on the first surface to be spaced apart from each other, a third connection electrode passing through a portion of the body to connect a first internal electrode, among the first internal electrodes, that is closest to the first surface and the third external electrode, and a fourth connection electrode passing through a portion of the body to connect a second internal electrode, among the second internal electrodes, that is closest to the first surface and the fourth external electrode.

14. The multilayer electronic component of claim 1, wherein at least one of the first ends has a first end surface facing the fifth surface of the body, and the first through-electrode is spaced apart from the end surface.

15. The multilayer electronic component of claim 14, wherein a center of at least one of the first internal electrodes is offset from a center of at least one of the second internal electrodes along the third direction.

16. The multilayer electronic component of claim 1, wherein at least one of the second ends has a second end surface facing the sixth surface of the body, and the second through-electrode is spaced apart from the end surface.

17. The multilayer electronic component of claim 1, wherein the first through-electrode is disposed between a plane in the first direction and the second direction passing through at least one of the first ends and a plane in the first direction and the second direction passing through at least one of the second ends.
